(19) United States
(12) Patent Application Publication
(10) Pub. No.: US 2014/0051281 A1
(43) Pub. Date: Feb. 20, 2014

(54) Passive Cable Adaptor With Battery Charging Capability

(71) Applicant: STMicroelectronics, Inc., Coppell, TX (US)

(72) Inventor: Alan Osamu KOBAYASHI, Los Altos, CA (US)

(73) Assignee: STMicroelectronics, Inc., Coppell, TX (US)

(21) Appl. No.: 13/965,982

(22) Filed: Aug. 13, 2013

Related U.S. Application Data
(60) Provisional application No. 61/682,958, filed on Aug. 14, 2012.

(51) Int. Cl. H01R 31/00

(52) U.S. Cl. CPC H01R 31/005
USPC 439/502

(57) ABSTRACT

A multimedia sink device comprises: 1) a connector configured to be connected to an adaptor cable; 2) detection circuitry configured to detect when the adaptor cable is connected to the connector; and 3) hot plug detection (HPD) circuitry configured to determine if a configuration circuit is coupled to an HPD line of the multimedia sink device. In response to a determination that the configuration circuit is coupled to the HPD line, the HPD circuitry determines if the configuration circuit is associated with the adaptor cable. The HPD circuitry reads configuration data from the configuration circuit associated with the adaptor cable. The configuration data indicates the configuration circuit is resident in the cable adaptor and causes the multimedia sink device to increase a voltage level of a power supply voltage provided by the multimedia sink device to a multimedia source device via the adaptor cable.

CROSS-REFERENCE TO RELATED APPLICATION(S) AND CLAIM OF PRIORITY

The present application is related to U.S. Provisional Patent No. 61/682,958, filed Aug. 14, 2013, entitled “PASSIVE CABLE ADAPTOR WITH BATTERY CHARGING CAPABILITY.” Provisional Patent No. 61/682,958 is assigned to the assignee of the present application and is hereby incorporated by reference into the present application as if fully set forth herein. The present application hereby claims priority under 35 U.S.C. §119(e) to U.S. Provisional Patent No. 61/682,958.

### TECHNICAL FIELD OF THE INVENTION

The present application relates generally to a cable adaptor for coupling a multimedia source device to a multimedia sink device and, more specifically, to a cable adaptor with battery charging capability.

### BACKGROUND

The VESA DisplayPort™ (DP) standard specifies an open digital communications interface for use in both internal connections, such as interfaces within a personal computer (PC) or monitor, and external display connections. Suitable external display connections include interfaces between a PC and monitor or projector, between a PC and a TV, or between a device such as a DVD player and a TV display. The DP standard is designed to accommodate the growing broad adoption of digital display technology within the PC and consumer electronics (CE) industries. It consolidates internal and external connection methods to reduce device complexity, supports necessary features for key cross-industry applications, and provides performance scalability to enable the next generation of displays featuring higher color depths, refresh rates, and display resolutions.

The DP link is a cable connector that connects a multimedia source device (e.g., laptop PC, DVD player) and a multimedia sink device (e.g., a TV monitor) and comprises a main link, an auxiliary channel, and a Hot Plug Detect (HPD) signal line. The main link is a unidirectional, high-bandwidth and low-latency channel used to transport isochronous data streams, such as uncompressed video and audio. The auxiliary channel is a half-duplex, bidirectional channel used for link management and device control. The HPD signal also serves as an interrupt request by the multimedia sink device.

The DP cable connector may be used with a variety of multimedia source devices and sink devices. In particular, the source devices and sink devices may operate from a power cord or may operate from an internal, rechargeable battery. It is desired to provide the VESA DisplayPort™ (DP) standard with enhanced flexibility in identifying whether one or the other of the source device and the sink device is operating on battery power and to provide a recharge capability for that battery.

### SUMMARY

In one aspect of the disclosure, a multimedia sink device if provided. The multimedia sink device comprises: 1) a connector configured to be connected to an adaptor cable; 2) detection circuitry configured to detect when the adaptor cable is connected to the connector; and 3) hot plug detection (HPD) circuitry configured to determine if a configuration circuit is coupled to an HPD line of the multimedia sink device and, in response to a determination that the configuration circuit is coupled to the HPD line, to determine if the configuration circuit is associated with the adaptor cable.

In one embodiment, the HPD circuitry is further configured to read configuration data from the configuration circuit associated with the adaptor cable.

In another embodiment, the configuration data indicates the configuration circuit is resident in the cable adaptor.

In still another embodiment, the configuration data causes the multimedia sink device to increase a voltage level of a power supply voltage provided by the multimedia sink device to a multimedia source device via the adaptor cable.

In a further embodiment, the configuration circuit is an EEPROM.

In another aspect of the disclosure, a cable adaptor is provided. The cable adaptor comprises: 1) a first plug connector configured to be connected to a multimedia source device; 2) a second plug connector configured to be connected to a multimedia sink device; 3) a cable section coupling the first and second plug connectors; and 4) a configuration circuit associated with the adaptor cable configured to receive a signal from the multimedia sink device and, in response, to output configuration data to the multimedia sink device. The configuration data causes the multimedia sink device to increase a voltage level of a power supply voltage provided by the multimedia sink device to the multimedia source device via the adaptor cable.

In one embodiment, the configuration circuit associated with the adaptor cable is an EEPROM.

In another embodiment, the configuration data indicates the configuration circuit is resident in the cable adaptor.

In still another aspect of the disclosure, an integrated circuit chip is provided for use with a multimedia sink device. The integrated circuit chip comprises: 1) input circuitry configured to be coupled to an adaptor cable via a connector of the multimedia sink device; 2) detection circuitry configured to detect when the adaptor cable is connected to the connector; and 3) hot plug detection (HPD) circuitry configured to determine if a configuration circuit is coupled to an HPD line of the multimedia sink device. In response to a determination that the configuration circuit is coupled to the HPD line, the HPD circuitry determines if the configuration circuit is associated with the adaptor cable.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller might be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high level view of a multimedia source device and a multimedia sink device coupled by a passive cable adaptor according to an exemplary embodiment of the disclosure;

FIG. 2 is a detailed view of a multimedia source device and a multimedia sink device coupled by a passive cable adaptor according to an exemplary embodiment of the disclosure; and

FIG. 3 is a flow diagram illustrating the operation of a multimedia sink device and a passive capable adaptor according to an exemplary embodiment of the disclosure.

### DETAILED DESCRIPTION

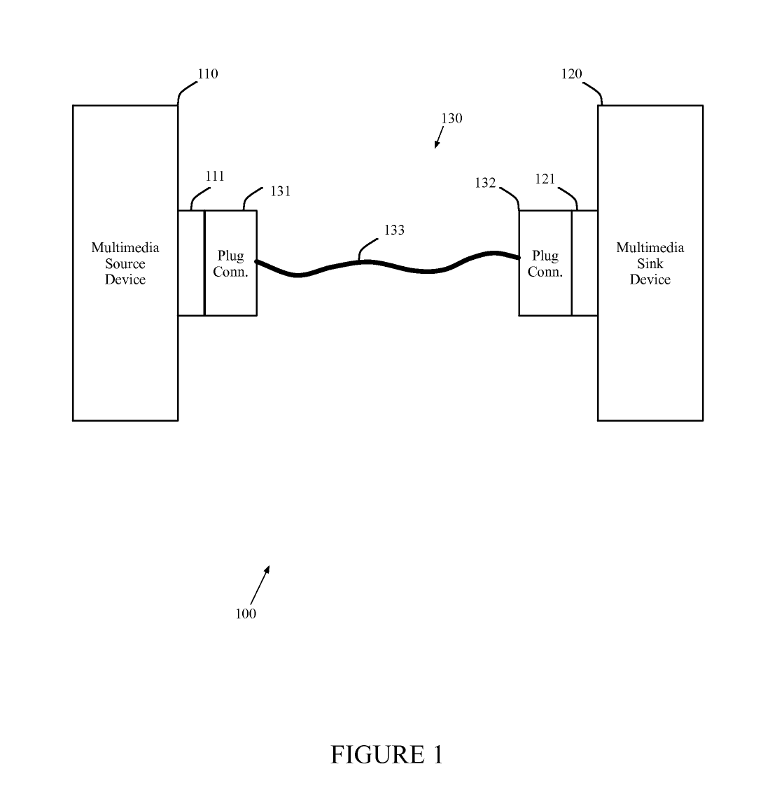

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged multimedia sink device, multimedia source device, and cable adaptor.

The present disclosure hereby incorporates by reference the VESA® Mobility DisplayPort® (MYDP) Standard, Version 1 (May 21, 2012) as if fully set forth herein. The present disclosure describes a passive cable adaptor and a multimedia sink device power wire and driver that 1) increase the power capacity to charge the battery of a multimedia source device while the power voltage level is set to, for example, 5 volts; and 2) enable the charging of a dead battery within a multimedia source device.

FIG. 1 is a high level view of multimedia system 100, which comprises multimedia source device 110, multimedia sink device 120 and passive cable adaptor 130 according to an exemplary embodiment of the disclosure. Source device 110 comprises connector 111 and sink device 120 comprises connector 121. Source device may comprise, for example, a laptop PC, a DVD player, or the like, and sink 120 may comprises, for example, a TV monitor or a built-in laptop screen.

Cable adaptor 130 comprises plug connector 131, plug connector 132, and bulk cable section 133. Plug connectors 131 and 132 terminate opposite ends of cable section 133 and may comprise, for example, molded plastic housings and metal pins that mate to connectors 111 and 121, respectively.

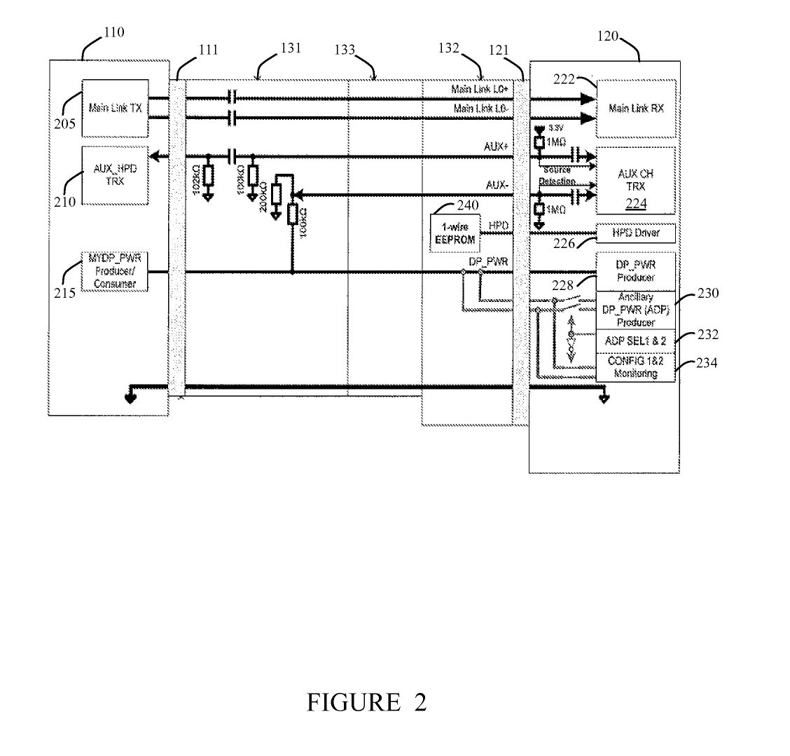

FIG. 2 is a detailed view of multimedia source device 110, multimedia sink device 120, and passive cable adaptor 130 according to an exemplary embodiment of the disclosure. In the exemplary embodiment, the interface between source device 110 and sink device 120 is compatible with the VESA DisplayPort standard. Thus, cable adaptor 130 comprises a main link, an auxiliary channel and a hot plug detect (HPD) signal. The main link comprises a unidirectional, high-bandwidth and low-latency channel used to transport isochronous data streams, such as uncompressed video and audio. The auxiliary channel is a half-duplex, bidirectional channel used for link management and device control. The HPD signal also serves as an interrupt request by multimedia sink device 120.

Source device 110 comprises main link transmitter (TX) circuitry 205, auxiliary/hot plug detect (HPD) transceiver (TRX) circuitry 210, and power producer/consumer block 215. In an advantageous embodiment, all or most of main link transmitter (TX) circuitry 205, auxiliary/hot plug detect (HPD) transceiver (TRX) circuitry 210, and power producer/consumer block 215 may be fabricated as a single integrated circuit chip, such as a system-on-a-chip (SoC). Sink device 120 comprises main link receiver (RX) circuitry 222, auxiliary channel transceiver (TRX) circuitry 224, hot plug detect (HPD) driver circuitry 226, DP power producer block 228, ancillary DP power producer block 230, ancillary power select block 232, and configuration 1 & 2 monitoring block 234. Similarly, all or most of main link receiver (RX) circuitry 222, auxiliary channel transceiver (TRX) circuitry 224, hot plug detect (HPD) driver circuitry 226, DP power producer block 228, ancillary DP power producer block 230, ancillary power select block 232, and configuration 1 & 2 monitoring block 234 may be fabricated as a system-on-a-chip (SoC).

The main link (L0+, L0−) may comprise one, two, or four AC-coupled, doubly terminated differential pairs (called lanes) that connect main link transmitter circuitry 205 and main link receiver circuitry 222. The AC-coupling capacitors in connector 131 facilitate the silicon process migration since the DisplayPort-compatible transmitter circuitry 210 and receiver circuitry 222 may have different common mode voltages. Three link rates may be supported, such as 5.4 Gbps, 2.7 Gbps and 1.62 Gbps per lane. All enabled lanes may operate at the same link rate. The link rate is decoupled from the pixel rate. The pixel rate is regenerated from the link symbol clock using the time stamp values M and N. The capabilities of the DisplayPort transmitter and receiver and the quality of the channel (or cable) determine whether the link rate is set to 5.4 Gbps, 2.7 Gbps or 1.62 Gbps per lane. All lanes in the main link carry data. There is no dedicated clock channel. The clock is extracted from the data stream itself, which may be is encoded with, for example, ANSI 8B/10B coding rule (channel coding specified in ANSI X3.230-1994, clause 11).

The auxiliary channel (AUX+, AUX−) comprises an AC-coupled, doubly terminated differential pair. Manchester-II coding may be used as the channel coding for the auxiliary channel (AUX CH). As is the case with the main link, the clock is extracted from the data stream. The auxiliary channel is half-duplex and bi-directional. Source device 110 is the master of the auxiliary channel and sink device 120 is the slave of the auxiliary channel. Sink device 120 may toggle the hot plug detect (HPD) signal to interrupt source device 110, which would prompt an auxiliary channel request transaction. The auxiliary channel provides a data rate of 1 Mbps over cable lengths of up to, for example, 15 meters or longer. In an exemplary embodiment, each transaction may take no more than, for example, 500 microseconds with a maximum burst data size of 16 bytes. This avoids auxiliary channel contention problems in which one application starves another application.

According to the principles of the present disclosure, power producer/consumer block 215 in source device 1110 may comprise a power supply unit that is charged from an external power cable (not shown) and a battery that may be charged from a downstream device, such as the DisplayPort power (DP_PWR) line of sink device 120.

Plug connector 131 of cable 130 comprises one-wire EEPROM 240, which is used to perform cable adaptor identification. One-wire EEPROM 240 uses one (1) pin as a self-clocked data pin as well as a power pin. Sink device 120 detects the plugging of passive cable adaptor 130 by detecting a connection to one-wire EEPOM 240. An example of such an EEPROM is described in Data Sheet DS24B33 provided by Maxim Integrated Products™, Inc., which is hereby incorporated into the present disclosure as if fully set forth herein.

The pull-up resistors in plug connector 131 and sink device 120 enable sink device 120 to detect a pulled down voltage level on AUX+ line when plug connector 132 is connected to connector 121 (i.e., source detection input to auxiliary channel transceiver circuitry 224). Upon detecting AUX+ pulled down, hot-plug detector (HPD) driver circuitry 226 in sink device 120 issues a 1-millisecond, low-going pulse (called IRQ HPD pulse) on the HPD line. If no AUX transaction is received in response to the IRQ_HPD pulse for more than 100 milliseconds, HPD driver circuitry 226 in sink device 120 generates self-clocked data on the HPD line to determine whether or not one-wire EEPROM 240 is present.

If the one-wire EEPROM 240 is present on the HPD line, HPD driver circuitry 226 in sink device 120 reads from EEPROM 240 the following data: 1) whether one-wire EEPROM 240 resides in passive cable adaptor 130 or not; and 2) whether cable adaptor 130 uses CONFIG1 and CONFIG2 pins for additional DP PWR delivery via ancillary DP power producer block 230.

Upon confirming that one-wire EEPROM resides in passive cable adaptor 130, sink device 120 changes DP PWR voltage to +5 volts from, for example, +3.3 volts. Furthermore, if cable adaptor 130 indicates that the CONFIG1 and CONFIG2 pins are used for additional power (DP_PWR) delivery, sink device 120 enables CONFIG1 and CONFIG2 outputs as ancillary DP_PWR outputs at +5 volts, using internal switches in sink device 120 and extra pins in plug connector 132 that are coupled to the DP_PWR line.

In an exemplary embodiment, each of the DP PWR producer 228 output pin, the CONFIG1 output pins, and the CONFIG2 output pins is capable of 650 mA of current, a total of about 2 A of current may be carried, resulting in approximately 10 W of power being delivered from sink device 120 to source device 110. As sink device 120 enables the +5 volt power level of DP_PWR based on the presence of one-wire EEPROM 240 and information in one-wire EEPROM 240, the above-described scheme enables the charging of a battery in source device 110, even if the battery is completely drained and source device 110 is not operational.

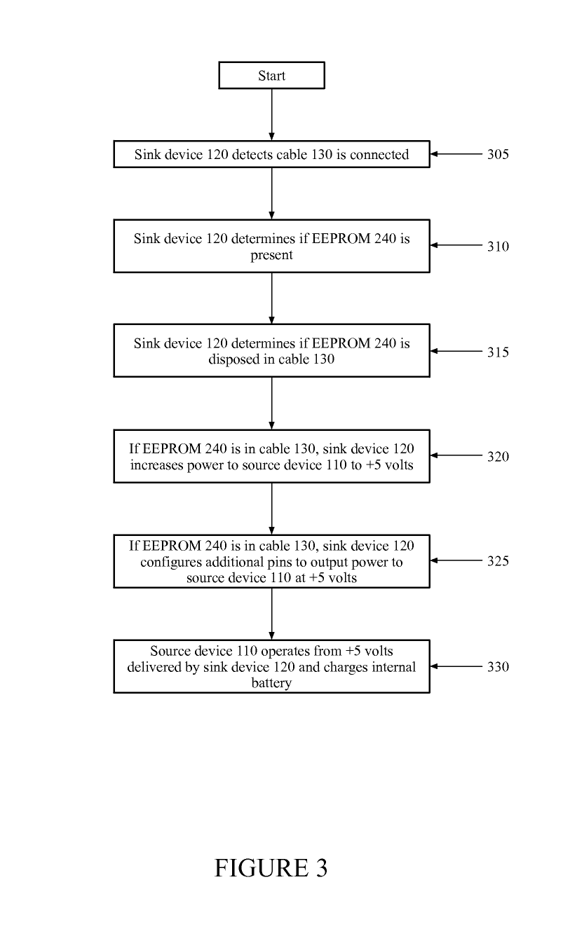

FIG. 3 is a flow diagram illustrating the operation of multimedia source device 110, multimedia sink device 120, and passive cable adaptor 130 according to an exemplary embodiment of the disclosure. Initially, sink device 120 detects that cable adaptor 130 is connected (step 305). Assuming cable adaptor 130 is connected, sink device 120 transmits a self-clocked data signal to determine if EEPROM 240 is present on the HPD line (step 310). If EEPROM 240 is present (i.e., a response is received), sink device 120 determines if EEPROM 240 resides in cable 130 (step 315).

If EEPROM 240 is resident in cable 130, sink device 120 increases power to source device 110 to +5 volts (step 320). Sink device 120 also configures additional pins to output power to source device 110 at +5 volts (step 325). Thereafter, source device 110 operates from the +5 volt power delivered by sink device 120 and charges its internal battery (step 330).

In an alternate embodiment of the disclosure, one-wire EEPROM 240 may be disposed in plug connector 131 instead of plug connector 132. Likewise, some of all of the pull-up/load resistors in plug connector 131 may be disposed in plug connector 132 instead.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An adaptor cable comprising:
a first plug connector configured to be connected to a multimedia source device;
a second plug connector configured to be connected to a multimedia sink device;
a cable section coupling the first and second plug connectors; and
a configuration circuit associated with the adaptor cable configured to receive a signal from the multimedia sink device and, in response, to output configuration data to the multimedia sink device, wherein the configuration data causes the multimedia sink device to increase a voltage level of a power supply voltage provided by the multimedia sink device to the multimedia source device via the adaptor cable.

2. The adaptor cable of claim 1, wherein the configuration circuit associated with the adaptor cable is an EEPROM.

3. The adaptor cable of claim 1, wherein the configuration data indicates the configuration circuit is resident in the cable adaptor.

4. A multimedia sink device comprising:
a connector configured to be connected to an adaptor cable;
detection circuitry configured to detect when the adaptor cable is connected to the connector; and
hot plug detection (HPD) circuitry configured to determine if a configuration circuit is coupled to an HPD line of the multimedia sink device and, in response to a determination that the configuration circuit is coupled to the HPD line, to determine if the configuration circuit is associated with the adaptor cable.

5. The multimedia sink device of claim 4, wherein the HPD circuitry is further configured to read configuration data from the configuration circuit associated with the adaptor cable.

6. The multimedia sink device of claim 5, wherein the configuration data indicates the configuration circuit is resident in the cable adaptor.

7. The multimedia sink device of claim 6, wherein the configuration data causes the multimedia sink device to increase a voltage level of a power supply voltage provided by the multimedia sink device to a multimedia source device via the adaptor cable.

8. The multimedia sink device of claim 7, wherein the configuration circuit is an EEPROM.

9. For use with a multimedia sink device, an integrated circuit chip comprising:
input circuitry configured to be coupled to an adaptor cable via a connector of the multimedia sink device;
detection circuitry configured to detect when the adaptor cable is connected to the connector; and
hot plug detection (HPD) circuitry configured to determine if a configuration circuit is coupled to an HPD line of the multimedia sink device and, in response to a determination that the configuration circuit is coupled to the HPD line, to determine if the configuration circuit is associated with the adaptor cable.

10. The integrated circuit chip of claim 9 wherein the HPD circuitry is further configured to read configuration data from the configuration circuit associated with the adaptor cable.

11. The integrated circuit chip of claim 10, wherein the configuration data indicates the configuration circuit is resident in the cable adaptor.

12. The integrated circuit chip of claim 11, wherein the configuration data causes the multimedia sink device to increase a voltage level of a power supply voltage provided by the multimedia sink device to a multimedia source device via the adaptor cable.

13. The integrated circuit chip of claim 12, wherein the configuration circuit is an EEPROM.
